(19) United States
(12) Patent Application Publication
(10) Pub. No.: US 2007/0142046 A1
(43) Pub. Date: Jun. 21, 2007

(54) Method and system for acquiring a carrier system by a terminal device

(76) Inventor: William E. Welnick, Poway, CA (US)

Correspondence Address: MOTOROLA INC, 600 NORTH US HIGHWAY 45, ROOM AS437, LIBERTYVILLE, IL, 60048-5343, US

(21) Appl. No.: 11/304,481

(22) Filed: Dec. 15, 2005

(51) Int. Cl. H04Q 7/20

(52) U.S. Cl. 455/434

(57) ABSTRACT

A method in a terminal device (102) for acquiring a carrier system identified in an preferred roaming list (PRL) is disclosed. The method includes acquiring (202) a first carrier system from a first scan list, rearranging (204) the first scan list using a hashing algorithm to form a second scan list, removing (206) priority scanning for the first carrier system, and acquiring (208) a carrier system from the second scan list.

### FIELD OF THE DISCLOSURE

This disclosure relates generally to mobile devices, and in particular to acquiring carrier systems in mobile communication networks.

### BACKGROUND OF THE DISCLOSURE

With the addition of subscribers on a communication network, service providers are hard pressed for ways to increase their system capacity. One way to address this problem involves expanding the capacity of the network by adding carriers in multiple frequency bands per geographical area. An example of network capacity expansion can be seen in Code Division Multiple Access (CDMA) communication. Currently, the bands used for CDMA communication include a Cellular band, operating at 800 MHz, and a Personal Communication System (PCS) band, operating at 1900 MHz. The result of the expansion of the capacity of the CDMA network is that a single CDMA service provider may have carrier systems across multiple bands in the same geographical area.

A mobile phone upon powering up, accesses a preferred roaming list (PRL) stored within it. The PRL is subdivided into different geographical groups (GEO groups). Each GEO group includes a system table having a scan list, which maps to a list of carrier systems in the GEO group. The carrier systems referenced by the scan list are arranged in a particular order for acquisition. The mobile phone tries to acquire the carrier systems in the order of their arrangement. Ideally, the number of subscribers on each of the available carrier systems in a CDMA network should be equal in order to balance the subscriber load. However, existing methods do not ensure equal distribution, since a majority of mobile phones in a particular geographic area may have been provided with the same PRL, resulting in their acquiring the same carrier system. For example, if the PRL provided to the majority of mobile phones in a particular geographic area has a carrier system with the highest order for acquisition in the Cellular band, then the mobile phones load up the carrier systems in the Cellular band and fail to equally load up the PCS band. This problem is especially troublesome in the home GEO group, i.e. the GEO group where the user is based. In the home GEO group, the PRL allows for multiple home carrier systems, but has no way of distributing the mobile phones evenly across the multiple home carrier systems.

Current load balance mechanisms, such as Channel List Messaging (CLM) and Extended Channel List Messaging (ECLM) are being used to overcome the above limitation. However, they do not allow the mobile phone to be distributed across band boundaries.

### BRIEF DESCRIPTION OF THE DRAWINGS

The present invention is illustrated by way of example and not limitation in the accompanying figures, in which like references indicate similar elements, and in which:

FIG. 1 shows an exemplary environment in which various embodiments of the present invention can be practiced.

FIG. 2 is a flowchart illustrating a method whereby a terminal device acquires a carrier system, according to an embodiment.

FIG. 3 is a flowchart illustrating a method for acquiring a first carrier system by a terminal device, according to an embodiment.

FIG. 4 shows a flowchart illustrating a first hashing algorithm, according to an embodiment.

FIG. 5 shows an exemplary scan list that has been modified by using a first hashing algorithm, according to an embodiment.

FIG. 6 shows a flowchart illustrating a second hashing algorithm, according to an embodiment.

FIG. 7 shows an exemplary scan list that has been modified by using a second hashing algorithm, according to an embodiment.

FIG. 8 shows a flowchart illustrating a third hashing algorithm, according to an embodiment.

FIG. 9 shows an exemplary scan list that has been modified by using a third hashing algorithm, according to an embodiment.

FIG. 10 shows a terminal device, according to an embodiment.

FIG. 11 shows a controller of a terminal device for acquiring a carrier system, according to an embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

A method for acquiring a carrier system from a plurality of carrier systems is provided. A terminal device acquires a carrier system by using a scan list provided to it. The terminal device creates a second scan list using a hashing algorithm. After creating the second scan list, the terminal device removes priority scanning for a carrier system. The terminal device then acquires a carrier system using the second scan list. The terminal device then camps on the carrier system acquired from the second scan list.

In accordance with another embodiment, a terminal device is provided. The terminal device includes a receiver, a memory capable of storing a Preferred Roaming List (PRL), and a controller coupled to the receiver and the memory. The controller further includes a scanning module, a hashing module, and a deletor module.

Before describing in detail a particular method and system for acquiring carrier system by terminal device, it should be observed that the present invention resides primarily in combinations of method steps and apparatus components related to method and system for acquiring carrier system by terminal device. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising”, “includes”, “including”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

A “set” as used in this document, means a non-empty set (i.e., comprising at least one member). The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

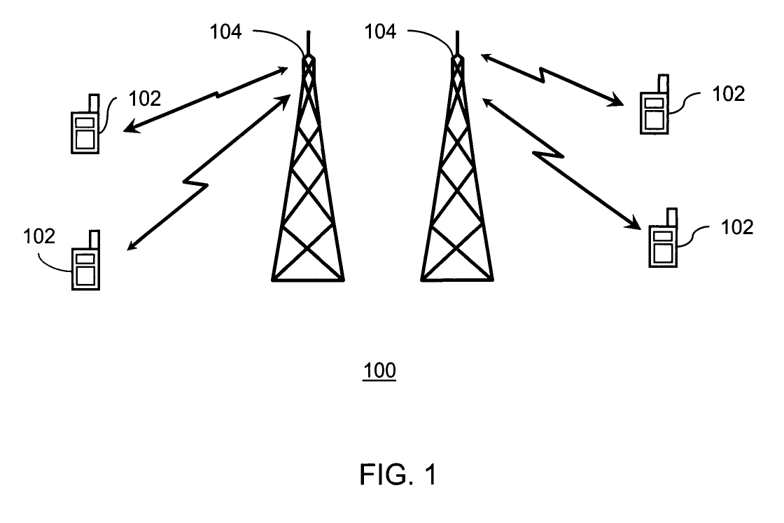

FIG. 1 shows an exemplary environment in which various embodiments of the present invention can be practiced. The environment 100 includes a plurality of terminal devices 102 and a plurality of Base Transceiver Stations (BTSs) 104. The plurality of terminal devices 102 has hereinafter been referred to as terminal devices 102. The plurality of BTSs 104 has hereinafter been referred to as BTSs 104. A terminal device 102 can be, for example, a CDMA cellular telephone. Other examples for the terminal device 102 (sometimes also called user equipment or a mobile station) include a cellular modem, a personal digital assistant (PDA) with a wireless interface, and other device using CDMA radio access technology. Still further examples for the terminal device 102 include devices with multi-mode radio access technologies, such as GSM-CDMA.

The terminal device 102 acquires a carrier system in order to transmit and receive information. In order to enable the terminal device 102 to acquire a carrier system, a Preferred Roaming List (PRL) is stored in the terminal device 102. The PRL stores information regarding a plurality of carrier systems that a service provider desires to be available to the terminal device. The plurality of carrier systems is divided into a plurality of geographical groups, also referred to as GEO groups, based on the geographic location of the carrier system. For example, all the carrier systems in a city would be included in one GEO group for that city. Each of the plurality of GEO groups contains a scan list. The scan list has a list of scanning frequencies arranged in a predefined order. Each scanning frequency maps to a carrier system. The scan list includes the scanning frequencies for both home carrier systems and roam carrier systems. Home carrier systems are the most preferred carrier systems for the terminal device 102. Roam carrier systems are either carrier systems owned by the service provider located in a different geographic location or carrier systems owned by different service providers located in the same geographic location. Typically, in a scan list, home carrier systems will have a higher order for acquisition than roam carrier systems. The terminal device 102 uses the scan list of the GEO group in which it is located to acquire the carrier system.

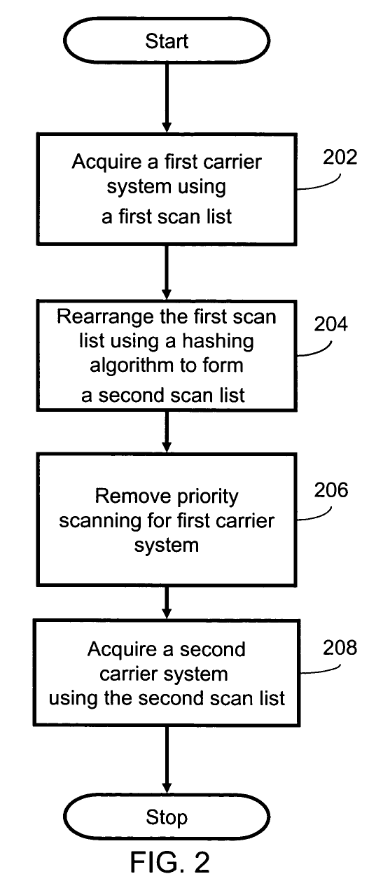

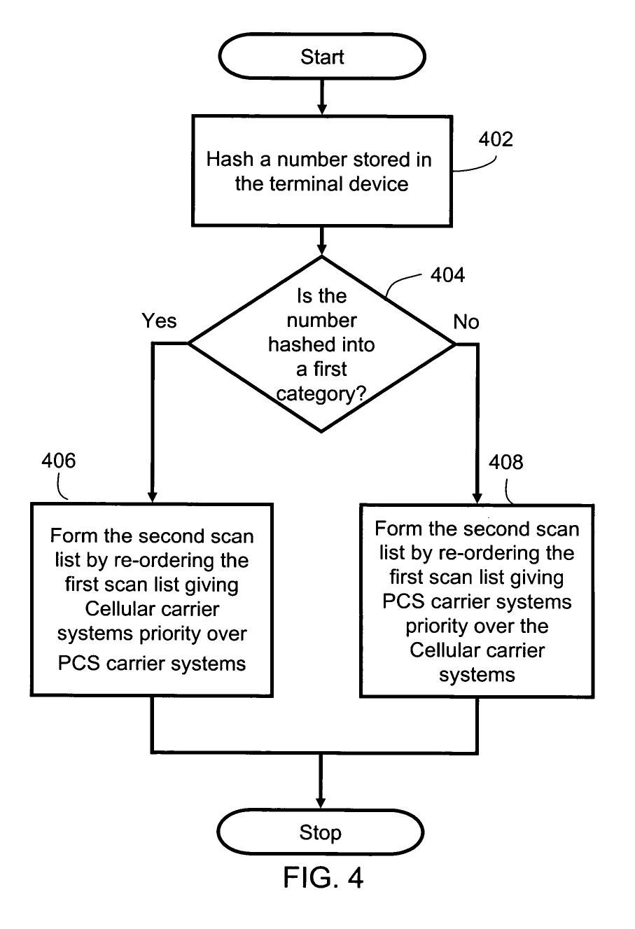

FIG. 2 is a flowchart illustrating a method whereby the terminal device 102 acquires a carrier system, according to an embodiment. At step 202, the terminal device 102 acquires a first carrier system using a first scan list. The first scan list is a scan list present in the PRL of the terminal device 102. In one embodiment, step 202 is performed after the terminal device 102 powers up. At step 204, a second scan list is formed by rearranging the scanning frequencies present in the first scan list. The rearrangement is done using a hashing or other randomizing algorithm. Different hashing algorithms that can be used to rearrange the scanning frequencies are described in detail in conjunction with FIGS. 4, 6, and 8. The second scan list includes the plurality of carrier systems present in the first scan list, but the order of the carrier systems can be different. In one embodiment, only the scanning frequencies of the home carrier systems are rearranged.

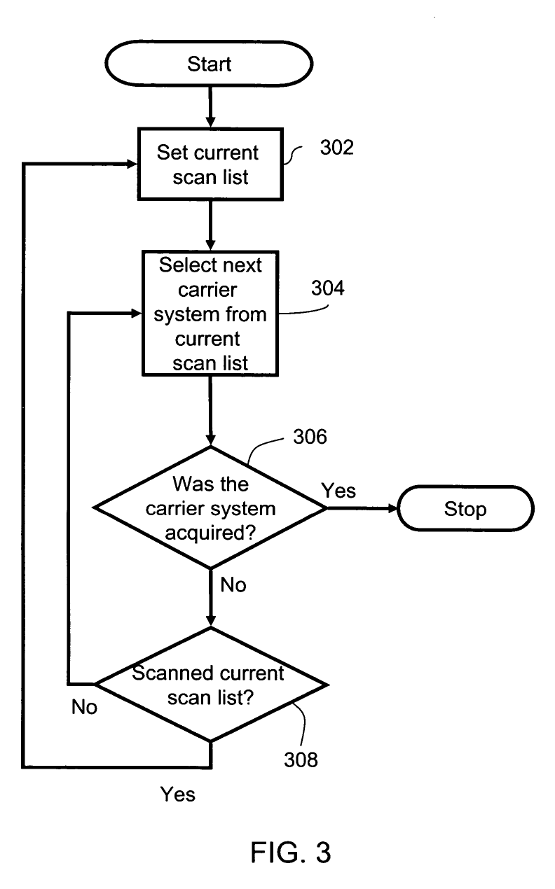

At step 206, priority scanning for the first carrier system is removed. Presently, when the terminal device 102 acquires a carrier system, the information regarding the carrier system is copied into a Most Recently Used (MRU) list. In removing the priority scanning for the first carrier system, the entry in the MRU list corresponding to the first carrier system is removed. This ensures that the terminal device 102 does not automatically try to camp again on the first carrier system in case the carrier system is lost. A terminal device loses a carrier system when the terminal device moves out of the coverage area of a BTS 104, which provides the carrier system, to an area having no coverage. At step 208, the terminal device 102 acquires a carrier system using the second scan list. The step of acquiring a carrier system from a first or second scan list is further described in conjunction with FIG. 3.

FIG. 3 is a flowchart illustrating a method for acquiring a first carrier system by a terminal device, according to an embodiment. At step 302, the terminal device 102 sets a scan list. The terminal device 102 sets a scan list by either retrieving the scan list from its memory or preparing the scan list using a hashing or other randomizing algorithm. The scan list includes a list referencing carrier systems arranged in a particular order. The order of the carrier systems in the scan list determines the order for acquisition of carrier systems. A carrier system with the highest order will be first on the scan list. Similarly, the carrier system with the lowest order will be last on the scan list. At step 304, the terminal device 102 tries to acquire the carrier system having the highest order in the scan list. In acquiring a carrier system, the terminal device 102 tries to capture a carrier channel that is part of that carrier system. At step 306, the terminal device 102 checks whether the target carrier system was acquired. If the carrier system with the highest order could not be acquired, step 308 is performed. At step 308, the terminal device 102 checks whether the entire scan list set in step 302 has been scanned. This ensures that the terminal device 102 has tried to acquire each carrier system in the scan list. If at step 308, the terminal device 102 finds that the entire scan list has not been scanned, then the terminal device 102 tries to acquire the carrier system with the next highest order at step 304. The terminal device 102 will continue doing this until it either acquires a carrier system or it exhausts all the carrier systems in the scan list. If the terminal device 102 exhausts all the carrier systems in the scan list without successfully acquiring a carrier system, then it sets the scan list again, and the method restarts at step 302.

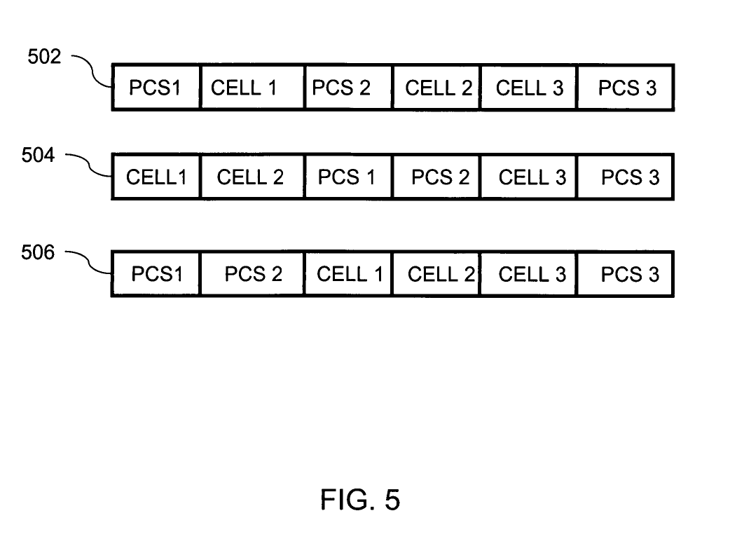

FIG. 4 shows a flowchart illustrating a first hashing algorithm, according to an embodiment. At step 402, the terminal device 102 hashes a number stored in the terminal device 102. In one embodiment, the number to be hashed is a Mobile Identification Number (MIN) of the terminal device 102. The MIN is number that uniquely identifies terminal devices. In another embodiment, the number to be hashed is a secondary hash key stored in the terminal device 102. The secondary hash key is a unique hash key provided to the terminal device 102. The number of the terminal device 102 may be hashed into one of two predefined categories. In one embodiment, the terminal device 102 forms the second scan list by re-ordering the carrier systems of the first scan list depending on the resulting category of the hashing algorithm result. At step 404, the terminal device 102 checks the category of the hashed number. If the number is hashed into a first category, then step 406 is performed. At step 406, the terminal device 102 forms the second scan list by re-ordering the first scan list giving the one or more Cellular carrier systems a higher order than the one or more PCS carrier systems. If the number is hashed into a second category, step 408 is performed. At step 408, the terminal device 102 forms the second scan list by re-ordering the first scan list giving the one or more PCS carrier systems priority over the one or more Cellular carrier systems. The first hashing algorithm is further elaborated in conjunction with FIG. 5.

FIG. 5 shows a sample scan list that has been modified by using a first hashing algorithm, according to a sample embodiment. A scan list 502 is the scan list already present in the terminal device 102. The scan list 502 includes home carrier systems PCS 1, CELL 1, PCS 2 and CELL 2 and roam carrier systems CELL 3 and PCS 3 in a particular order. This scan list 502 may be programmed in a significant majority of terminal devices 102 served by a single service provider. The terminal device 102 uses the scan list 502 to acquire the first available carrier system, PCS 1. A second scan list 504 is formed by rearranging the scanning frequencies in the scan list 502 according to the results of the first hashing algorithm. The scan list 504 is formed if the number stored in terminal device 102 hashes to the first category, as determined by step 404. In the scan list 504, the home Cellular carrier systems are given a higher order than the home PCS carrier systems. Hence, the home carrier systems CELL 1 and CELL 2 are located before the home carrier systems PCS 1 and PCS 2 in the scan list 504. Another second scan list 506 is formed by rearranging the scan list 502 if the number stored in terminal device 102 hashes to the second category, as determined by step 404. In the scan list 506, the home PCS carrier systems are given a higher order than the home Cellular carrier systems. Hence, the home carrier systems PCS 1 and PCS 2 are located before the home carrier systems CELL 1 and CELL 2 in the scan list 506. The order of the roam carrier systems CELL 3 and PCS 3 remains unchanged in the scan lists 502, 504 and 506, because roam carrier systems are not rearranged in this embodiment.

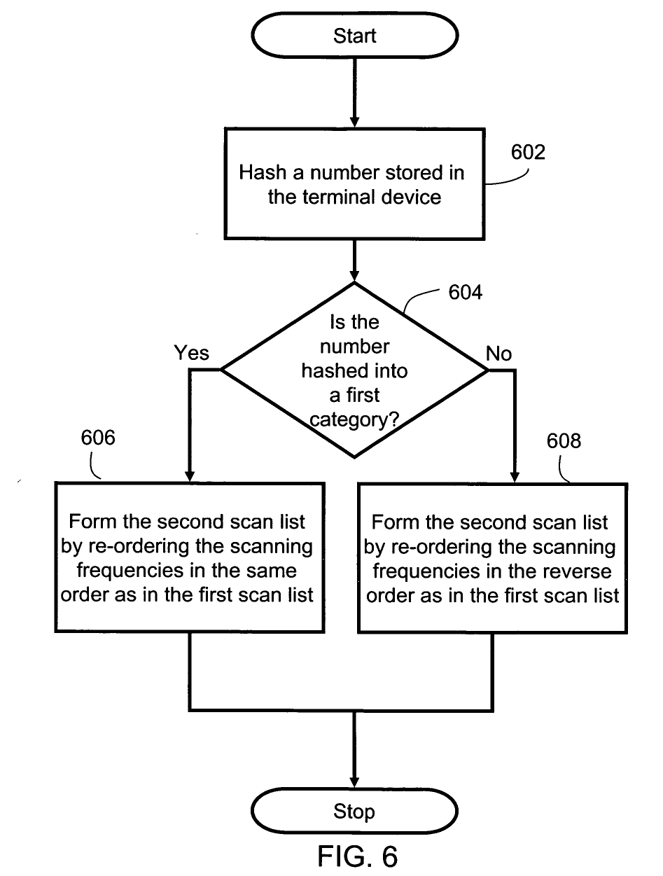

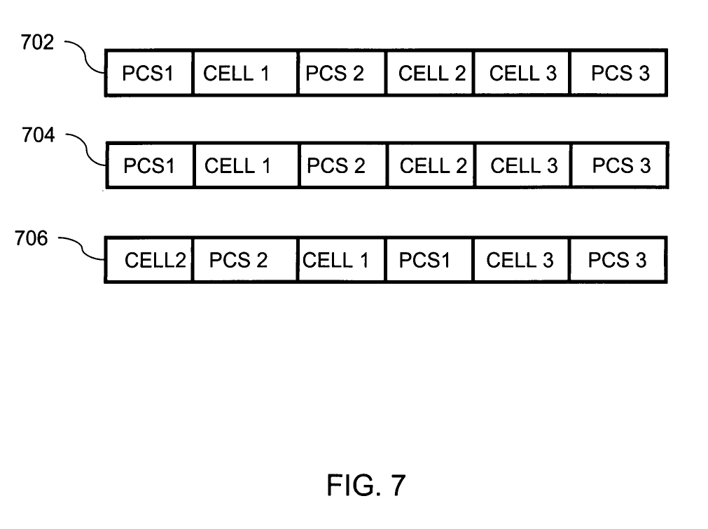

FIG. 6 shows a flowchart illustrating a second hashing algorithm, according to an embodiment. At step 602, the terminal device 102 hashes a number stored in the terminal device 102. In one embodiment, the number to be hashed is a Mobile Identification Number (MIN) of the terminal device 102. In another embodiment, the number to be hashed is a secondary hash key stored in the terminal device 102. The results of the hashing algorithm may be classified into one of two predefined categories. In one embodiment, the terminal device 102 forms the second scan list by either maintaining or reversing the ordering of the home carrier systems in the first scan list. At step 604, the terminal device 102 checks the category into which the results of the hashing algorithm have been classified. If the result is classified into a first category, then step 606 is performed. At step 606, the terminal device 102 forms the second scan list by re-ordering two or more of the carrier systems in the same order as the carrier systems arranged in the first scan list. If the hashing result is classified into a second category, then at step 608, the terminal device 102 forms the second scan list by reversing the order of two or more of the carrier systems in the first scan list. The second hashing algorithm is further elaborated in conjunction with FIG. 7.

FIG. 7 shows a sample scan list that has been modified by using a second hashing algorithm, according to another sample embodiment. A scan list 702 is the scan list already present in the terminal device 102. The scan list 702 includes home carrier systems PCS 1, CELL 1, PCS 2 and CELL 2, and roam carrier systems PCS 3 and CELL 3 in a particular order for acquisition. The terminal device 102 uses the scan list 702 to acquire the first available carrier system, for example PCS 1. A second scan list 704 is formed by rearranging the scan list 702 if the number stored in terminal device 102 hashes to the first category. In the scan list 704, the home carrier systems have the same order as the carrier systems in the scan list 702. Another second scan list 706 is formed by rearranging the scan list 702 if the number stored in the terminal device 102 hashes to the second category. In the scan list 706, the order of the home carrier systems is a reversal of the order of the home carrier systems in the scan list 702. The order of the carrier systems CELL 3 and PCS 3 remains unchanged in the scan lists 702, 704 and 706, because roam carrier systems are not rearranged in this embodiment.

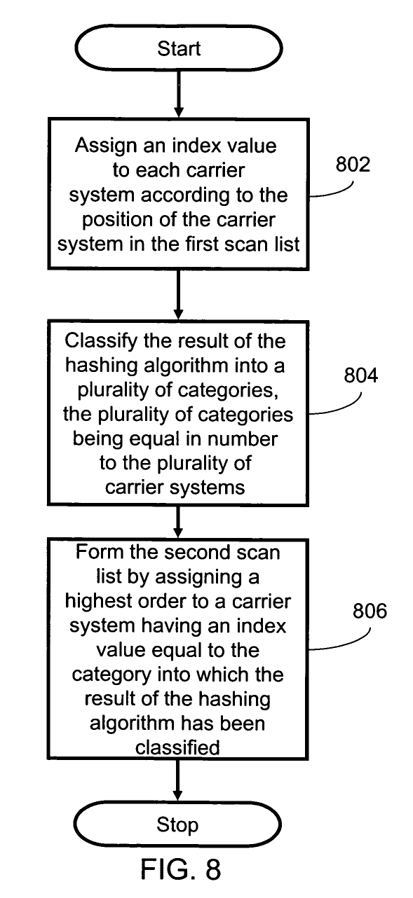

FIG. 8 shows a flowchart illustrating a third hashing algorithm, according to an embodiment. At step 802, the terminal device 102 assigns an index value to each home carrier system present in the first scan list according to the position of the home carrier system in the first scan list. The index value assigned to the first home carrier system in the first scan list is 0. The index value assigned to the second home carrier system in the first scan list is 1. Similarly, all home carrier systems in the first scan list are assigned an index number. The last home carrier system in the first scan list will be assigned an index number of (N−1), where N is the number of home carrier systems in the first scan list.

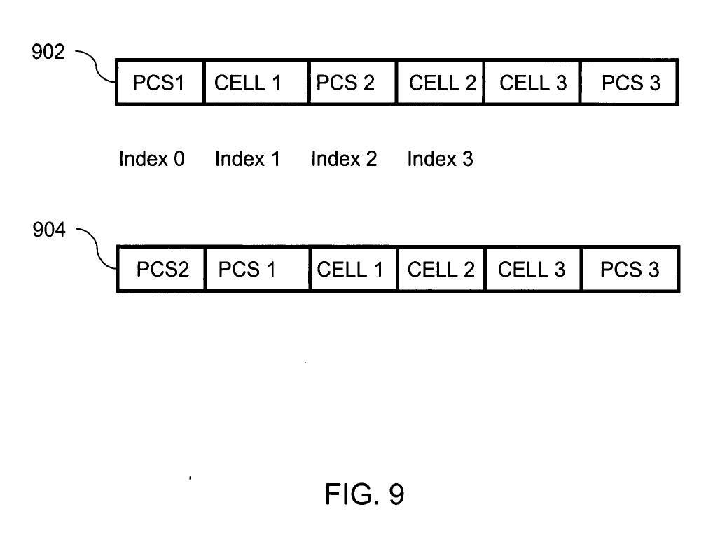

At step 804, the number stored in the terminal device 102 is hashed into one of 0 to N−1 categories. In one embodiment, the number to be hashed is the Mobile Identification Number (MIN) of the terminal device 102. In another embodiment, the number to be hashed is a secondary hash key stored in the terminal device 102. At step 806, the second scan list is formed by giving the highest order to the home carrier system having an index value equal to the category into which the number stored in the terminal device 102 is hashed. Hence, the home carrier system, corresponding to the index value to which the number stored in the terminal device 102 is hashed to, is placed at the first position in the second scan list. The other carrier systems of the first scan list are moved accordingly in the second scan list. The third hashing algorithm is further elaborated in conjunction with FIG. 9.

FIG. 9 shows a sample scan list that has been modified by using the third hashing algorithm, according to another sample embodiment. The scan list 902 is the scan list already present in the terminal device 102 and is similar to scan list 502 and 702 previously described. The terminal device 102 assigns an index value to each home carrier system present in the first scan list according to the position of the home carrier system in the first scan list. For example, in the scan list 902, the home carrier systems are assigned the following index values: a home carrier system PCS 1 is assigned an index value of 0, a home carrier system CELL 1 is assigned an index value of 1, a home carrier system PCS 2 is assigned an index value of 2, and a home carrier system CELL 2 is assigned an index value of 3. The number stored in the terminal device 102 is hashed into one of the 0 to N−1 categories. In this example, the number stored in the terminal device 102 is hashed into one of four categories, 0-3. If the result of hashing is equal to 2, the terminal device 102 forms a second scan list 904 by giving the home carrier system with an index value equal to 2 the highest order. Hence, the home carrier system PCS 2 having an index value of 2 is assigned the highest order in the second scan list 904.

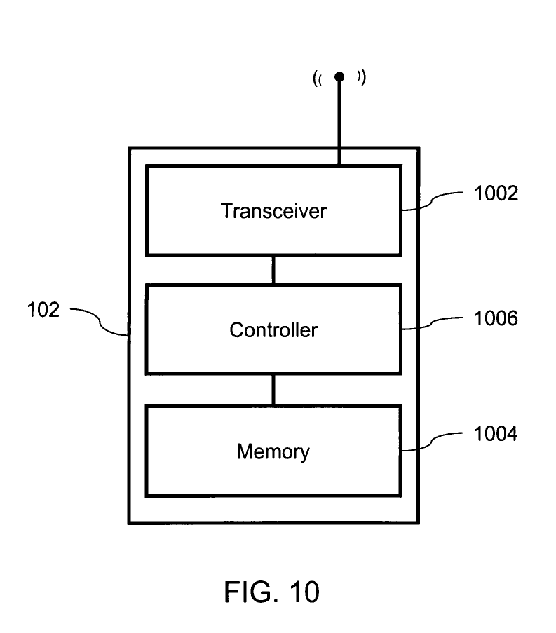

FIG. 10 shows a terminal device 102, according to an embodiment. The terminal device 102 includes a transceiver 1002, a memory 1004 and a controller 1006. The terminal device 102 can be, for example, a CDMA cellular telephone. Other examples of the terminal device 102 include a cellular modem and a personal digital assistant (PDA) with a wireless interface. Other devices using alternate radio access technologies can be substituted for the CDMA cellular telephone shown. The transceiver 1002 receives an electric signal from an antenna of the terminal device 102. The memory 1004 stores a PRL. The PRL stores information regarding the carrier systems to be acquired by the terminal device 102. The PRL divides the carrier systems according to the geographic location of the carrier system. Hence, the PRL is divided into a number of geographic groups (GEO groups). A GEO group includes a scan list. The scan list has a list of scanning frequencies arranged in a predefined order. A scan list contains the scanning frequencies for both home carrier systems and roam carrier systems. In one embodiment, each GEO group in the PRL is provided with a GEO mask. The GEO mask is a bit identifying whether a second scan list will be created for a particular GEO group. For example, a GEO group having a GEO mask equal to 1 will use a hashing algorithm to create a second scan list while a GEO group having a GEO mask equal to 0 will not create a second scan list. In one embodiment, the GEO mask is a binary word with the number of bits equal to the number of GEO groups in the PRL. Each GEO group has a unique entry in the GEO mask. The unique entry dictates to the terminal device 102 whether the particular GEO group will use a hashing algorithm to create a second scan list.

The terminal device 102 uses the scan list of the GEO group in which it is located to acquire the carrier system. The controller 1006 in the terminal device 102 is responsible for manipulating the scan list included in the PRL if permitted according to the GEO mask.

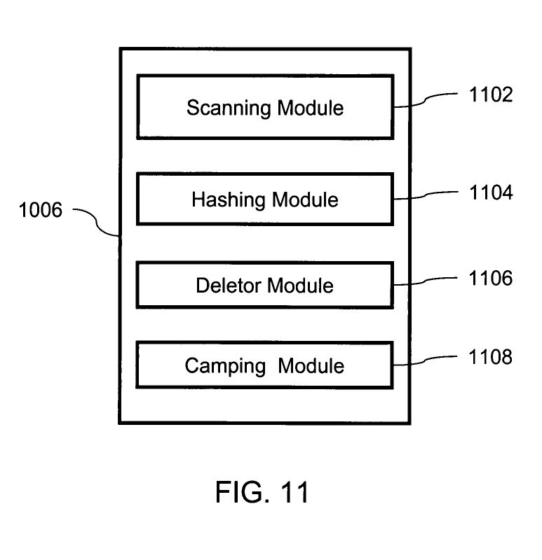

FIG. 11 shows a controller 1006 of a terminal device 102 for acquiring a carrier system, according to an embodiment. The controller 1006 includes a scanning module 1102, a hashing module 1104, a deletor module 1106 and a camping module 1108. The scanning module 1102 is responsible for setting a scan list. In setting a scan list, the scanning module 1102 extracts the scan list from the memory 1004.

The scanning module 1102 is responsible for acquiring a first carrier system using the extracted scan list. After the scanning module 1102 has acquired the first carrier system, the hashing module 1104 creates a second scan list. The second scan list can be created, for example, based on one of the three flowcharts described in conjunction with FIGS. 4, 6 and 8. After the hashing module 1104 has created a second scan list, the deletor module 1106 removes the priority scanning for the first carrier system acquired by the scanning module 1102. In removing the priority, the deletor module 1106 removes information regarding the first carrier system from an MRU list stored in the terminal device 102.

After the priority scanning has been removed, the scanning module 1102 acquires a carrier system using the second scan list. The camping module 1108 enables the terminal device 102 to camp on a carrier system. In one embodiment, if the terminal device 102 is allowed to camp on an acquired carrier system, then the camping module 1108 marks the system as allowed, and if the terminal device 102 is not allowed to camp on an acquired carrier system, then the camping module 1108 marks the system as avoided. Hence, the camping module 1108 ensures that the terminal device 102 does not camp on the first carrier system.

Various embodiments of the present invention ensure a balanced distribution of terminal devices across multiple bands. By manipulating the scan list stored in the terminal device, it can be ensured that carrier systems that are presently under-utilized can be utilized in a better manner. Also, overloaded carrier systems can have some of their load reduced. This is achieved with negligible infrastructure changes. Various embodiments also enable wireless communication devices, capable of certain services, to camp on an appropriate carrier system. In addition, various embodiments of the invention provide the freedom of not using the hashing algorithm in certain GEO groups by providing a special hash key.

It will be appreciated the method and system for acquiring carrier system by terminal device described herein may be comprised of one or more conventional processors and unique stored program instructions that control the one or more processors to implement, in conjunction with certain non-processor circuits, some, most, or all of the functions of the method and system for acquiring carrier system by terminal device described herein. The non-processor circuits may include, but are not limited to, a radio receiver, a radio transmitter, signal drivers, clock circuits, power source circuits, and user input devices. As such, these functions may be interpreted as steps of a method to acquire a communication system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for acquiring a carrier system from amongst a plurality of carrier systems, the plurality of carrier systems being represented in a first scan list of scanning frequencies stored in a terminal device, the method comprising:
acquiring a first carrier system using the first scan list;
rearranging scanning frequencies in the first scan list using a result of a randomizing algorithm to form a second scan list;
removing priority scanning for the first carrier system; and
acquiring a second carrier system using the second scan list.

2. The method according to claim 1, wherein the plurality of carrier systems includes a first-band carrier system operating at a first frequency band and a second-band carrier system operating at a second frequency band.

3. The method according to claim 2, wherein the rearranging the scanning frequencies comprises:
classifying the result of the randomizing algorithm into one of at least a first category and a second category;
forming the second scan list by re-ordering the first scan list wherein the first-band carrier system has priority over the second-band carrier system when the result of the randomizing algorithm is classified into the first category; and
forming the second scan list by re-ordering the first scan list wherein the second-band carrier system has priority over the first-band carrier system when the result is classified into the second category.

4. The method according to claim 1, wherein the rearranging the scanning frequencies comprises:
classifying the result of the randomizing algorithm into one of at least a first category and a second category;
forming the second scan list by re-ordering at least two scanning frequencies in a same order as in the first scan list when the result of the randomizing algorithm is classified into the first category; and
forming the second scan list by re-ordering the at least two scanning frequencies in a reverse order as in the first scan list when the result of the randomizing algorithm is classified into the second category.

5. The method according to claim 1, wherein the randomizing algorithm comprises:
assigning an index value to at least two carrier systems according to the position of the at least two carrier systems in the first scan list;
classifying the result of the randomizing algorithm into a plurality of categories, the plurality of categories being equal in number to the at least two carrier systems with assigned index values; and
forming the second scan list by assigning a highest order to a carrier system having an index value equal to the category into which the result of the randomizing algorithm has been classified.

6. The method according to claim 1, wherein the randomizing algorithm uses a number stored in the terminal device.

7. The method according to claim 6, wherein the randomizing algorithm is a hashing algorithm.

8. The method according to claim 7, wherein the number stored in the terminal device is a Mobile Identification Number (MIN) of the terminal device, wherein the MIN is used as a hash key for the hashing algorithm.

9. The method according to claim 7, wherein the number stored in the terminal device other than a Mobile Identification Number (MIN) is a secondary hash key of the terminal device, wherein the secondary hash key is used as a hash key for the hashing algorithm.

10. The method according to claim 1 further comprising using the randomizing algorithm to form the second scan list when the first carrier system has been lost.

11. The method according to claim 1, wherein removing priority scanning for the first carrier system comprises removing the first carrier system from a Most Recently Used (MRU) list.

12. The method according to claim 1 further comprising camping on the second carrier system.

13. The method according to claim 1 wherein the second carrier system is identical to the first carrier system.

14. The method according to claim 1, wherein the first scan list is present in a geographical group (GEO group), the GEO group being one amongst a plurality of GEO groups, wherein a predetermined set of GEO groups from amongst the plurality of GEO groups is identified by a GEO mask, and only the predetermined set of GEO groups is enabled to generate the second scan list.

15. The method according to claim 14, wherein the GEO mask comprises entries, wherein each entry represents a particular GEO group, and each entry determines if the rearranging of the scanning frequencies is permitted in the particular GEO group.

16. A terminal device comprising:
a receiver;
a memory capable of storing a Preferred Roaming List (PRL), the PRL having at least a first scan list, the first scan list having a plurality of scanning frequencies related to a plurality of carrier systems; and
a controller coupled to the receiver and the memory, the controller comprising:
a scanning module for directing the receiver to scan a scan list to select a carrier system, the scanning module further capable of acquiring the carrier system; and
a hashing module for obtaining a second scan list using a hashing algorithm, wherein the hashing algorithm hashes a number stored in the terminal device.

17. The terminal device of claim 16 wherein the controller further comprises a deletor module for removing a most recently acquired carrier system from a Most Recently Used list.

18. The terminal device of claim 16 wherein the controller further comprises a camping module for directing the receiver to camp on an acquired carrier system.

19. The terminal device according to claim 16, wherein the number stored in the terminal device is a Mobile Identification Number (MIN) of the terminal device, wherein the MIN is used as a hash key.

20. The terminal device according to claim 16, wherein the number stored in the terminal device is other than a Mobile Identification Number (MIN).
